(19) United States
(12) Patent Application Publication
(10) Pub. No.: US 2009/0232478 A1
(43) Pub. Date: Sep. 17, 2009

(54) AUDIO SERVICE PLAYBACK METHOD AND APPARATUS THEREOF

(76) Inventors: Ching-Ming Chen, Taipei City (TW); Tien-Hsin Kuo, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/046,456

(22) Filed: Mar. 12, 2008

(51) Int. Cl. H04N 5/91

(52) U.S. Cl. 386/96

(57) ABSTRACT

An audio service playback method includes receiving a transport stream including bitstreams corresponding to at least a main audio service and at least an auxiliary audio service; extracting audio service information of the bitstreams; displaying an audio service selection menu according to the extracted audio service information, wherein the audio service selection menu includes an audio effect option corresponding to the auxiliary audio service; and when a user selection is received via the audio service selection menu, playing at least one of the bitstreams according to the user selection. In addition, an audio service playback apparatus includes a receiving module, a controlling module coupled to the receiving module, and an output module coupled to the controlling module. In this way, the audio service playback method and apparatus thereof allow users to select the auxiliary audio service they want to experience.

### BACKGROUND OF THE INVENTION

1. Field of the Invention

The present invention relates to audio service playback methods, and more particularly, to a method for setting an audio service in an audio service playback apparatus.

2. Description of the Prior Art

In digital television (DTV) technology, audio language service is a common audio service in a standard program selection menu. Please refer to FIG. 1. FIG. 1 is a diagram illustrating an audio selection menu 10 corresponding to a particular program. As shown in FIG. 1, there are three language tracks available for the program: English, French and Spanish, as shown in the audio selection menu 10. When English is selected via the audio selection menu 10, dialogue will be played in English along with the program. Likewise, when French or Spanish is selected via the audio selection menu 10, dialogue will be played in French or Spanish along with the program. In this way, the language of the program can be selected according to personal preference.

However, in the ATSC standard A/54a, an AC-3 elementary stream contains several other audio services. ATSC Digital TV Standards include digital high definition television (HDTV), standard definition television (SDTV), data broadcasting, multi-channel surround-sound audio, and satellite direct-to-home broadcasting. Thus, there is a need to use these audio services in order to enrich the visual and acoustic environment.

### SUMMARY OF THE INVENTION

It is therefore one of the objectives of the present invention to provide an audio service playback method and related method capable of playing a number of audio services, to solve the above-mentioned problem.

According to an exemplary embodiment of the claimed invention, an audio service playback method is disclosed. The audio service playback method comprises receiving a transport stream including bitstreams corresponding to at least a main audio service and at least an auxiliary audio service; extracting audio service information of the bitstreams; displaying an audio service selection menu according to the extracted audio service information, wherein the audio service selection menu includes an audio effect option corresponding to the auxiliary audio service; and when a user selection is received via the audio service selection menu, playing at least one of the bitstreams according to the user selection.

According to another exemplary embodiment of the claimed invention, an audio service playback apparatus is also disclosed. The audio service playback apparatus comprises: a receiving module, which is used for receiving a transport stream including bitstreams corresponding to at least a main audio service and at least an auxiliary audio service; a controlling module, which is coupled to the receiving module, and is used for extracting audio service information of the bitstreams outputted from the receiving module; and an output module, which is coupled to the controlling module, and is used for displaying an audio service selection menu according to the audio service information extracted by the controlling module, wherein the audio service selection menu includes an audio effect option corresponding to the auxiliary audio service. When a user selection is received via the audio service selection menu, the controlling module controls the output module to play at least one of the bitstreams according to the user selection.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an audio selection menu.

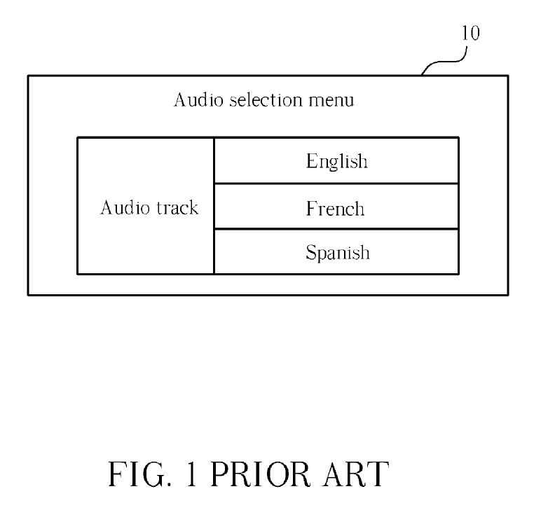

FIG. 2 is a block diagram illustrating an audio service playback apparatus according to an embodiment of the present invention.

FIG. 3 is a diagram illustrating an audio selection menu shown on the video output unit of the audio service playback apparatus.

FIG. 4 is a diagram illustrating the magnified audio selection menu.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

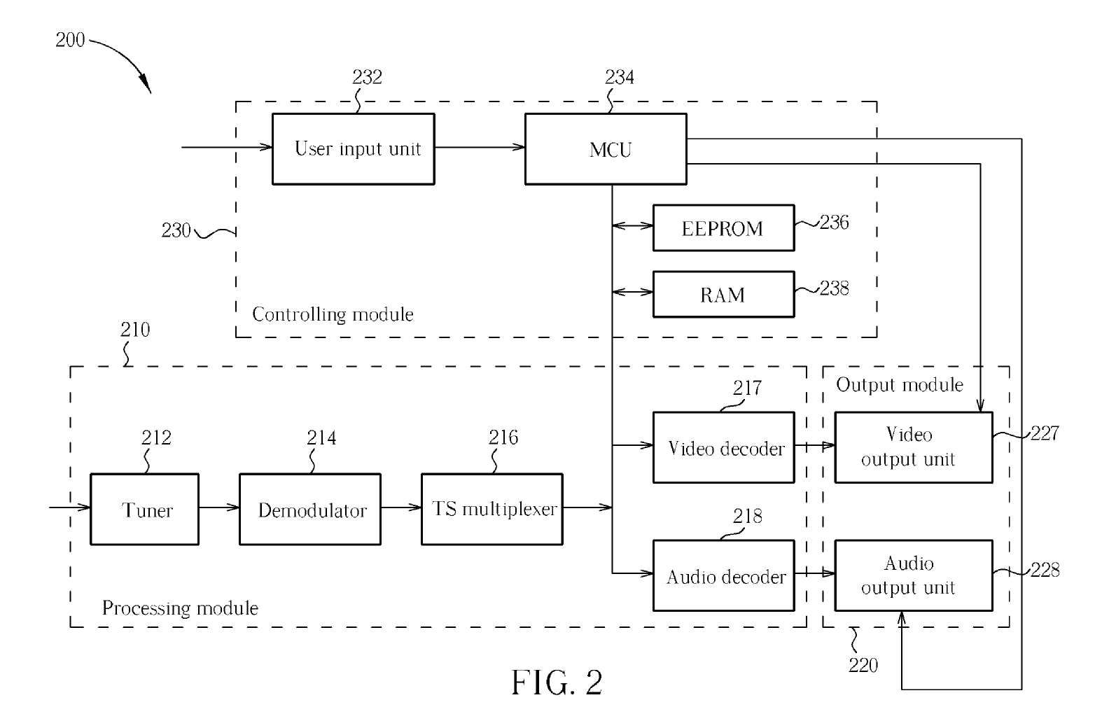

Please refer to FIG. 2. FIG. 2 is a block diagram illustrating an audio service playback apparatus 200 according to an embodiment of the present invention. In this embodiment, the audio service playback apparatus 200 is a DTV; however, this is not meant to be a limitation of the present invention. As shown in FIG. 2, the audio service playback apparatus 200 comprises, but is not limited to, a processing module 210, an output module 220 and a controlling module 230. The processing module 210 comprises a tuner 212 for receiving a TV broadcast signal; a demodulator 214 for demodulating the received TV broadcast signal to generate a transport stream; a transport stream (TS) demultiplexer 216 for extracting audio data, video data and auxiliary data from the transport stream, and respectively outputting bitstreams of the extracted data; a video decoder 217 for decoding the extracted video data and outputting a decoded video signal; and an audio decoder 218 for decoding the extracted audio data and outputting a decoded audio signal. The output module 220 comprises a video output unit 227 for displaying screen images according to the decoded video signal, and an audio output unit 228 for outputting a sound signal according to the decoded audio signal. The controlling module 230 comprises a user input unit 232 for receiving user selections; a micro controller unit (MCU) 234 for controlling the video output unit 227 and the audio output unit 228; an electrically-erasable programmable read-only memory (EEPROM) 236 for storing the extracted auxiliary data; and a random access memory (RAM) 238 for storing the extracted audio and video data.

In this embodiment, the TV broadcast signal received by the tuner 212 complies with the ATSC standard. For this reason, the bitstreams of the extracted audio data are AC-3 elementary streams, and the bitstreams of the extracted video data are MPEG-2 elementary streams. As mentioned in the prior art, there are several auxiliary audio services described in the ATSC standard A/54a, including visually impaired (VI), hearing impaired (HI), dialogue (D), commentary (C), emergency (E) and voice-over (VO). Each of the above auxiliary audio services provides a particular audio effect. The information related to the auxiliary audio services provided by the TV broadcast signal is included in the auxiliary data. Each of the auxiliary audio services is associated with one or more languages. In addition, the information related to the language and its corresponding auxiliary audio services is included in the auxiliary data.

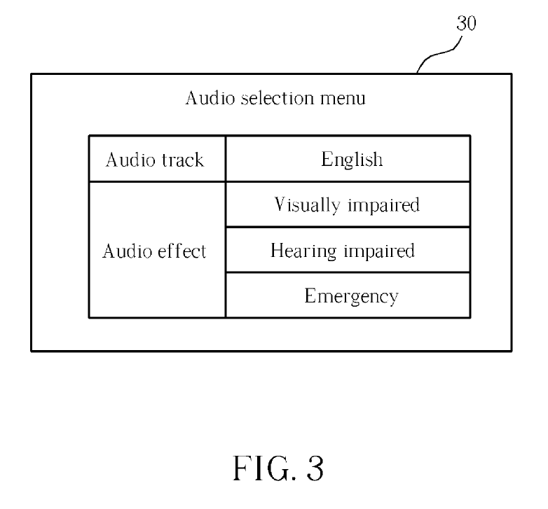

According to the auxiliary data stored in the EEPROM 236, the MCU 234 is able to control the video output unit 227 to display an audio selection menu, which includes audio effect options for providing the available auxiliary audio services to users. Please refer to FIG. 3. FIG. 3 is a diagram illustrating an audio selection menu 30 shown on the video output unit 227 of the audio service playback apparatus 200. The audio selection menu shows the available audio effects provided in English. As shown in FIG. 3, there are three audio effect options respectively corresponding to three types of auxiliary audio services: visually impaired (VI), hearing impaired (HI) and emergency (E), for users to select via the audio selection menu 30. For example, when the user input unit 232 receives a user selection corresponding to the emergency (E) auxiliary audio service, the MCU 234 retrieves the emergency (E) audio data corresponding to English from the RAM 238 and conveys the bitstream of the retrieved audio data to the audio decoder 218 so as to play an audio effect of the emergency (E) auxiliary audio service.

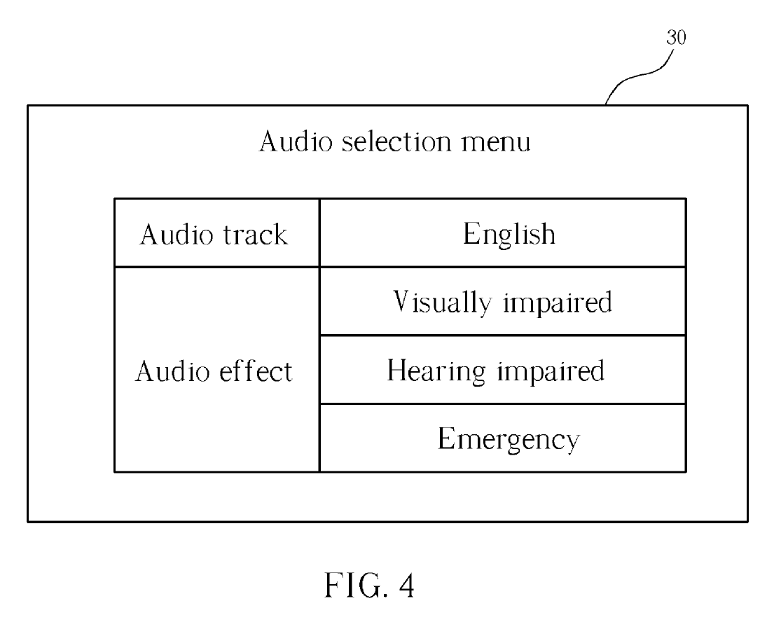

Please note that when some types of specific auxiliary audio services are selected, the video output unit 227 or the audio output unit 228 performs a predetermined task for the specific auxiliary audio service. For example, when the user input unit 232 receives a user selection corresponding to the visually impaired (VI) auxiliary audio service, the MCU 234 retrieves the visually impaired (VI) audio data corresponding to English from the RAM 238 and conveys the bitstream of the retrieved audio data to the audio decoder 218 so as to play an audio effect of the visually impaired (VI) auxiliary audio service. In addition, upon the auxiliary audio service VI being selected, the MCU 234 controls the video output unit 227 to magnify the on screen display (OSD) font size and layout of the audio selection menu 30 for the visually impaired (VI) auxiliary audio service, as shown in FIG. 4. FIG. 4 is a diagram illustrating the magnified audio selection menu 30.

On the other hand, when the user input unit 232 receives a user selection corresponding to the hearing impaired (HI) auxiliary audio service, the MCU 234 retrieves the hearing impaired (HI) audio data corresponding to English from the RAM 238 and conveys the bitstream of the retrieved audio data to the audio decoder 218 so as to play an audio effect of the hearing impaired (HI) auxiliary audio service. In addition, upon the hearing impaired (HI) auxiliary audio service being selected, the MCU 234 controls the audio output unit 228 to play a sound effect (e.g., beep-beep) to notify the user.

It should be noted that the above predetermined tasks are for illustrative purposes only and are not limitations of the prevent invention. For example, when the user input unit 232 receives a user selection corresponding to the hearing impaired (HI) auxiliary audio service, the MCU 234 can further control the audio output unit 228 to play the program at full volume regardless of the original volume.

Compared with the prior art, the audio service playback apparatus 200 of the present invention provides not only audio language service but also all kinds of auxiliary audio services for users to select. Furthermore, the audio service playback apparatus 200 performs predetermined tasks for some types of specific auxiliary audio services. In this way, the visual and acoustic environment becomes richer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An audio service playback method, comprising:
receiving a transport stream including bitstreams corresponding to at least an auxiliary audio service;
extracting audio service information of the bitstreams;
displaying an audio service selection menu according to the extracted audio service information, wherein the audio service selection menu includes an audio effect option corresponding to the auxiliary audio service; and
when a user selection is received via the audio service selection menu, playing at least one of the bitstreams according to the user selection.

2. The audio service playback method of claim 1, wherein the step of displaying the audio service selection menu comprises:
displaying the audio effect option corresponding to a specific audio language.

3. The audio service playback method of claim 1, wherein the step of receiving the transport stream comprises:
receiving a broadcast signal; and
processing the broadcast signal to generate the transport stream.

4. The audio service playback method of claim 3, wherein the broadcast signal complies with a digital television standard.

5. The audio service playback method of claim 4, wherein the bitstreams are AC-3 elementary streams.

6. The audio service playback method of claim 5, wherein the auxiliary audio service is one of visually impaired (VI) audio service, hearing impaired (HI) audio service, dialogue (D) audio service, commentary (C) audio service, emergency (E) audio service and voice-over (VO) audio service.

7. The audio service playback method of claim 1, wherein the audio effect option corresponds to the auxiliary audio service designed for a visually impaired user, and the step of displaying the audio service selection menu further comprises:
when the user selection corresponds to the audio effect option, magnifying the audio service selection menu.

8. The audio service playback method of claim 1, wherein the audio effect option corresponds to the auxiliary audio service designed for a hearing impaired user, and the step of displaying the audio service selection menu further comprises:
when the user selection corresponds to the audio effect option, playing a sound effect when the user selection is received via the audio service selection menu.

9. The audio service playback method of claim 1, wherein the bitstreams are AC-3 elementary streams.

10. An audio service playback apparatus, comprising:
a processing module, for receiving a transport stream including bitstreams corresponding to at least an auxiliary audio service;
a controlling module, coupled to the receiving module, for extracting audio service information of the bitstreams outputted from the receiving module;
an output module, coupled to the controlling module, for displaying an audio service selection menu according to the audio service information extracted by the controlling module, wherein the audio service selection menu includes an audio effect option corresponding to the auxiliary audio service; and
when a user selection is received via the audio service selection menu, the controlling module controls the output module to play at least one of the bitstreams according to the user selection.

11. The audio service playback apparatus of claim 10, wherein the output module displays the audio effect option corresponding to a specific audio language.

12. The audio service playback apparatus of claim 10, wherein the processing module comprises
a receiving unit, for receiving a broadcast signal; and
a signal processing unit, for processing the broadcast signal to generate the transport stream.

13. The audio service playback apparatus of claim 12, wherein the broadcast signal complies with a digital television standard.

14. The audio service playback apparatus of claim 13, wherein the bitstreams are AC-3 elementary streams.

15. The audio service playback apparatus of claim 14, wherein the auxiliary audio service is one of visually impaired (VI) audio service, hearing impaired (HI) audio service, dialogue (D) audio service, commentary (C) audio service, emergency (E) audio service and voice-over (VO) audio service.

16. The audio service playback apparatus of claim 10, wherein the audio effect option corresponds to the auxiliary audio service designed for a visually impaired user, and when the user selection corresponds to the audio effect option, the controlling module controls the output module to magnify the audio service selection menu.

17. The audio service playback apparatus of claim 10, wherein the audio effect option corresponds to the auxiliary audio service designed for a hearing impaired user, and when the user selection corresponds to the audio effect option, the controlling module controls the output module to play a sound effect when the user selection is received via the audio service selection menu.

18. The audio service playback apparatus of claim 10, wherein the bitstreams are AC-3 elementary streams.
